(19) United States
(12) Patent Application Publication
(10) Pub. No.: US 2010/0308591 A1
(43) Pub. Date: Dec. 9, 2010

(54) INLINE HYDRO ELECTRIC GENERATION SYSTEM

(76) Inventor: Carl L. Godfrey, Temecula, CA (US)

Correspondence Address: STETINA BRUNDA GARRED & BRUCKER, 75 ENTERPRISE, SUITE 250, ALISO VIEJO, CA, 92656, US

(21) Appl. No.: 12/481,240

(22) Filed: Jun. 9, 2009

(51) Int. Cl. F03B 13/00

(52) U.S. Cl. 290/54

(57) ABSTRACT

An inline hydro electric generation system for harnessing the potential energy of water passing in existing water pipes is provided. The inline hydro electric generation system comprises a housing upon which a rotatable impeller with a plurality of impeller blades is mounted. The housing is affixed to a water pipe so that water passes from the water pipe into the housing subsequently initiating the impeller to mechanically rotate. The impeller is advantageously designed so that only one impeller blade is submerged under water as the impeller is mechanically rotated. An electrical generator is axially coupled to the impeller so that when the impeller rotates, the electrical generator generates electrical power. Subsequently, the water is departs from the housing and is returned into the water pipe to continue its route to its intended recipients. The inline hydro electric generation system provides a low cost and environmentally friendly alternative to conventional energy generation systems.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention pertains to water-driven electrical generators and, more particularly to an inline hydro electric generation system for generating power by harnessing the energy from water running in existing water pipes.

2. Description of the Related Art

Today, energy is a primary concern for all businesses and communities around the world. Every industrial nation is currently searching for new innovative means to generate and utilize energy. In this regard, vast resources are being invested in researching and developing new and alternative methods to enhance future energy generation. Currently, billions of dollars are being spent daily in this quest for energy. The magnitude of the increased energy demand, coupled with the infusion of this money has been the driving incentive that has consequently fueled exploration and review of the past, current and hopeful future technologies.

Currently, the greatest period of scientific advances in the energy industry is underway. With some successes come many failures, especially with proposed ‘new’ technologies. The expense researching new energy technologies is monumental and they generally fail to meet the cost effective deliverables of the technology. As a result, researchers have gone a short distance with the greatest expense ever seen in the energy industry.

At present, energy technologies fail to cater to areas where electrical power is not readily available. In this regard, remote locations are not provided with a reliable and effective power source. One of the most vital needs for new energy technology arises in providing electrical power to areas where power is not readily available. There are numerous situations where electrical power is not readily available, such as in the immediate aftermath of a natural disaster or at a remote location. Additionally, many energy technologies are not environmentally friendly. In this regard, the construction of dams and power plants are harmful to the environment.

A commonly known method to generate energy is to utilize the potential energy stored in water. As such, water wheels or paddle wheels have been used to turn small electric generators and industrial machinery. However, traditional water wheels suffer from many disadvantages. Most importantly, they must be located near an uninterrupted source of water to function. In addition, ice, debris, and imbalance of the wheel may negatively affect the performance of a water wheel. Therefore, constant maintenance and upkeep is required to ensure that a water wheel is optimally performing.

Additionally, a water wheel's performance is susceptible to nature. In this regard, a communities become vulnerable to floods or draughts. In order to address seasonal variations in weather, the construction of a dam may impound sufficient water to provide for energy purposes. However, there are drawbacks to dam construction. Dam construction is generally a timely process that is expensive and environmentally unfriendly. In addition, dams can be quite destructive when they are installed, in that communities are exposed to flooding by the water stored behind the dam. Consequently, this has been a cause for controversy in the past, especially when dams flood valleys used by peoples. In the event that a dam fails, it may also cause catastrophic flooding, and people downstream of a dam tend to experience a reduction in available water after it has been installed.

Other technologies exploiting the energy harnessed in water include tidal power and wave power. These technologies take advantage of the ocean's current to generate electrical power. However, these systems have been found to be very expensive, generally unreliable, and have not been effectively reduced to practice. Therefore these technologies are more theoretically appealing rather than being practical solutions. Additionally, there have been concerns raised that such technologies may prove damaging to marine life.

Therefore, there is currently a need in the art for a system and method for generating energy from water that can provide immediate energy solutions to remote locales while still being cost effective and environmentally friendly.

### BRIEF SUMMARY

In accordance with the present invention, there is provided multiple embodiments of a system and method for an inline hydro electric generation system. In a basic embodiment of the present invention, the system includes a housing defining an internal open space and opposed inlet and outlet openings for receiving the flow of water therethrough. A rotatable impeller is mounted within the open space and is positioned in between the inlet and outlet openings. The impeller may have numerous impeller blades radially extending about its periphery. Each impeller blade is positioned at angular intervals relative to a plane including the axis of the impeller. In addition, an electrical generator is mounted on the housing and is configured to be axially coupled to the impeller for producing energy upon a rotation of the impeller. The housing is further affixed to a water pipe so that water from the water pipe flows in through the inlet opening and the impeller is rotated by the current of the water, the water subsequently passes out of the housing back into the water pipe through the outlet opening. Additionally, the impeller is configured so that only one impeller board is submerged under water at a time.

In another embodiment of the present invention, the housing may include an inlet attachment point and an outlet attachment point that are capable of rigidly connecting to the water pipe. The inlet and outlet attachment points may be retrofitted to the water pipe via unions so that the water flows through the housing resulting in no water loss while sustaining a constant water pressure. The housing may further include an outer housing cover that substantially covers an upper portion of the impeller. The outer housing may be removed to provide access to the open space.

In another embodiment of the present invention, the impeller blades may have leading and trailing ends wherein the leading end is rounded. In addition, the body of an impeller blade may be configured to have grooves. The impeller blades may further be configured so that they are positioned at a 72 degree angle in relation to the axis of the impeller. The impeller blades may be made of ceramic, stainless steel, or composite. The impeller blades may also be sized so that they have a length ⅓ of the size of the diameter of a water pipe. Additionally, the impeller may include support structures positioned in between each impeller blade to provide adequate support.

In another embodiment of the present invention, the impeller may have a core which has an opening. The electric generator may be axially coupled to the impeller via a rotatable drive shaft that is inserted into the opening of the core. The drive shaft may subsequently be fastened to the housing with a bearing, wherein the bearing facilitates the rotation of the drive shaft while the drive shaft is coupled to the generator and the impeller.

In another embodiment of the present invention, the water pipes may be conventional in ground water pipes. In this regard, the inline hydro electric generation system may be adapted for multi-unit deployment in a water pipe system.

Further in accordance with the present invention, there is a provided a method for generating electrical power from an inline hydro electric generation system. The method initiates by providing a housing defining an internal open space and at least one inlet and outlet openings, the inlet opening is attached to a water pipe so that water flows into the housing, and the outlet opening is attached to the water pipe so that water flows back from the housing into the water pipe. The method continues by providing a rotatable impeller mounted in the open space between the inlet and outlet openings and having a plurality of radially extending impeller blades, wherein the impeller blades are configured so that only one blade is submerged under water during the rotation of the impeller. An electrical generator axially is coupled to the impeller so that when the impeller rotates the electrical generator produces electrical power. The method continues by passing a flow of water from a water pipe through the inlet opening so that the impeller rotates which subsequently generates electrical power from the electrical generator. The method concludes by passing the flow of water from the housing through the outlet opening back into the water pipe.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts an inline hydro electric generation system attached to a water pipe with an external electrical generator mounted on the outside of the housing;

FIG. 2 depicts an exploded view of the inline hydro electric generation system of FIG. 1, where all of the requisite components of the system are illustrated.

FIG. 3 depicts an operable inline hydro electric generation system that is configured so that only one impeller blade is submerged under water when the impeller is rotated;

FIG. 4 depicts a cross section of a grooved impeller blade with a rounded leading end and a trailing end.

Common reference numerals are used throughout the drawings and detailed descriptions to indicate like elements.

### DETAILED DESCRIPTION

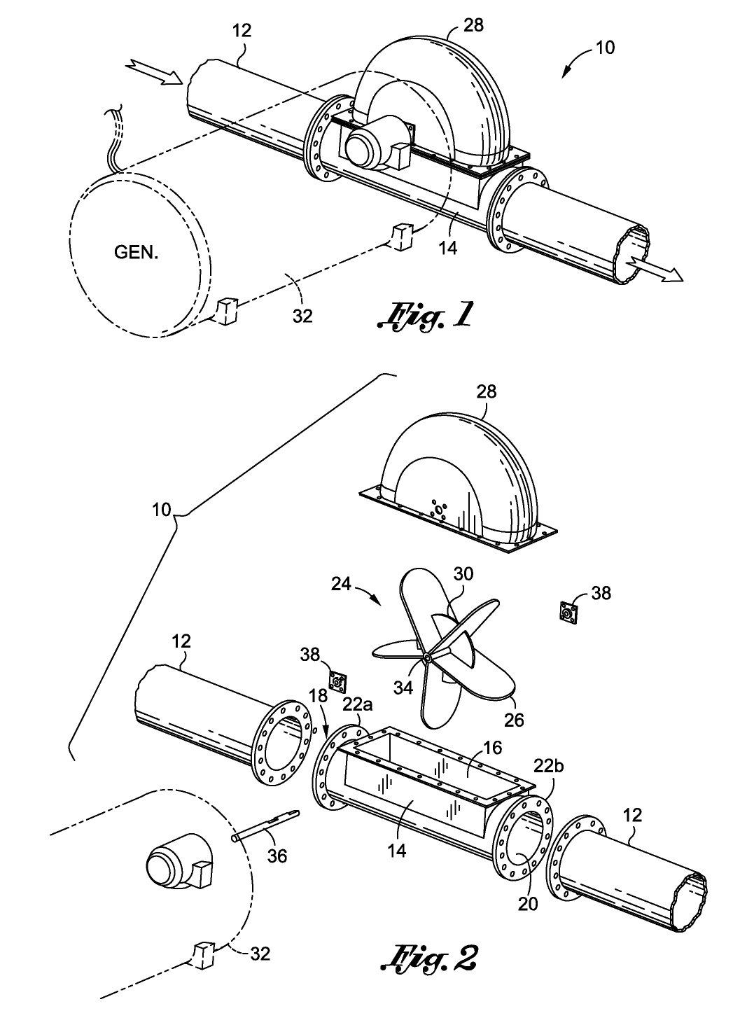

Referring now to the drawings wherein the showings are for purposes of illustration various embodiments of the present invention only, and not for purposes of limiting the same, FIGS. 1 and 2 depict an inline hydro electric generation system 10 constructed in accordance with the present invention. The inline hydro electric generation system 10 is an integrated system that utilizes existing water delivery systems as an energy source to generate electrical power. In the present embodiment the water delivery system is a conventional in ground water pipe 12. However, it is contemplated that the inline hydro electric generation system may be adapted to work with a variety of water delivery systems including a variety of water pipes such as in ground pipes, above ground pipes, water pipes that are housed in structures, and the like.

The inline hydro electric generation system 10 comprises a housing 14 defining an internal open space 16 with at least one opposed inlet 18 and outlet 20 openings for receiving a flow of water therethrough. Water passes from the water pipe 12 into the system 10 via the inlet opening 18. Subsequently, the water returns to the water pipe 12 by passing through the outlet opening 20. In the present embodiment, there is one inlet 18 and one outlet opening 20. However, it is contemplated that the system may be configured to employ numerous openings relative to the design and capacity of the water pipe 12. Additionally, the inline hydro electric generation system 10 advantageously maintains constant water pressure so that after the water flows through the system 10, the water reaches its intended delivery target with sufficient pressure. Generally, a water delivery system, such as existing water pipes 12, delivers water to homes and businesses. Therefore it is critical that water passing through the system 10 retains the requisite pressure needed by its intended recipients.

Furthermore, it is essential that there is no water loss when water passes through the inline hydro electric generation system 10. The purpose of the system 10 would be undermined if water pressure was compromised or if there were any water loss. In this regard, it is contemplated that the housing 14 includes inlet and outlet attachment points 22a, 22b which are retrofitted to the water pipe 12 via unions to prevent any water leakage in the system 10. A person having ordinary skill in the art would recognize that there are a variety of methods that may be employed to affix the inline hydro electric generation system 10 into an existing water pipe 12. As such, the system 10 may be permanently installed by welding the attachment points 22a, 22b to the water pipe 12. In the alternative, the system 10 may be temporarily installed on a water pipe 12 by utilizing conventional fasteners, unions, and the like. A temporary installation of the system 10 would permit the system to be employed as a temporary solution for immediate energy needs. Such solutions may be useful during times of emergency where energy production is limited or has been compromised. In addition, a temporary installation allows the system to be dynamic, in that the installation location may change in accordance to need. In this regard, as communities grow, water delivery systems are often remapped in accordance to a communities shifting needs. As such, the system 10 may be more efficiently utilized in alternative locations. Therefore, it is advantageous that the system 10 may be relocated to more desirable locations where an increase in water flow or a need for energy is present.

A rotatable impeller 24 is mounted within the open space 16. The orientation of the impeller 24 complements the positioning of the water pipe 12 so that the water current flowing into the housing 14 causes the impeller 24 to mechanically rotate. In the present embodiment the water pipe 12 is horizontally oriented. Therefore, the impeller 24 is vertically oriented relative to the water pipe 12 so that the water flows into the impeller 24. The rotation of the impeller is facilitated through numerous impeller blades 26 radially extending about the periphery of the impeller 24.

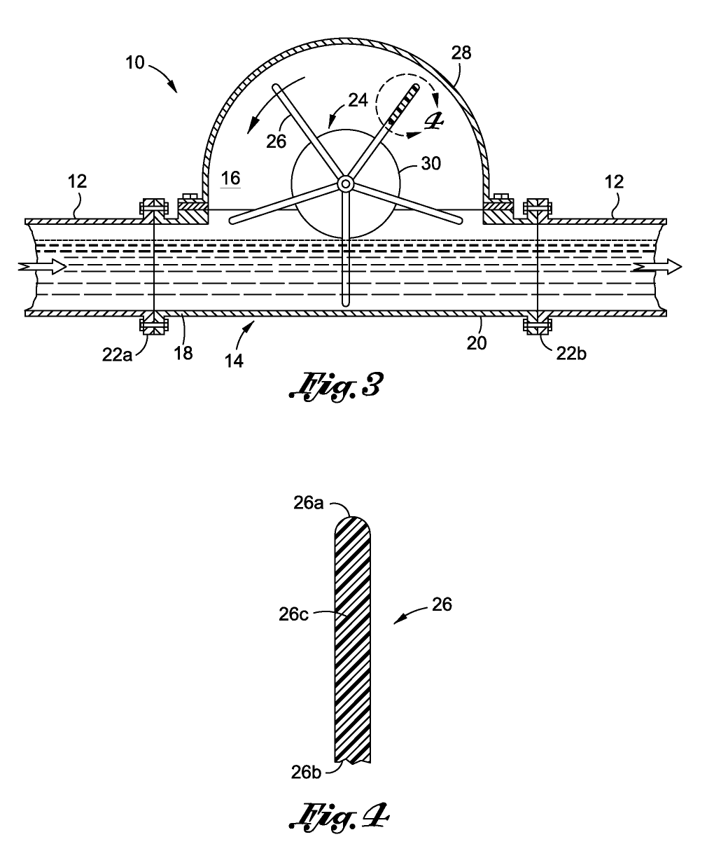

In the present embodiment, the impeller 24 is shown with five impeller blades 26. However, it is contemplated that one having ordinary skill in the art would recognize that various configurations of the impeller blades 26, including the number of blades and the size of the blades, may be adapted to conform to the specifications of the inline hydro electrical generation system 10 and the existing water pipe 12. FIG. 3, illustrates the impeller 24 being mechanically rotated by the current of the water as it passes from the water pipe 12 into the system 10. Additionally, each impeller blade 26 is positioned at angular intervals relative to a plane including the axis of the impeller 24.

The impeller 24 is advantageously designed so that only one impeller blade 26 is submerged under water at any given time. Thus, the rotation of the impeller 24 results in only one impeller blade 26 to be submerged under water as the remaining blades are positioned above the water. In this regard, in the present embodiment each impeller blade 26 is aligned at a 72 degree angle relative to the axis of the impeller 24. As such, the one blade under water design promotes a stable water pressure as water flows through the inline hydro electric generation system 10. Additionally, it has been found that the one blade under water design also encourages a more resourceful electrical output. It is contemplated that a person having ordinary skill in the art would recognize that the impeller blades 26 may be configured at varying angular degree relative to the dimensions of the system 10 in light of the amount of water flowing through the water pipe 12 so that only one impeller blade 26 is submerged under water. As such, regardless of the number of impeller blades 26 employed by the system 10 the one blade under water design must be maintained.

FIG. 4 illustrates a cross sectional view of an impeller blade 26. The impeller blade 26 is configured so that the impeller 24 is capable of being mechanically rotated by the water effectively. In the present embodiment, the impeller blades 26 have leading 26a and trailing 26b ends, wherein the leading end 26a is rounded. A rounded leading end 26a promotes effective navigation through the water. Additionally, in the present embodiment the body 26c of the impeller blade is configured to have grooves. The rounded leading end 26a and the grooved body 26c advantageously promote the sustenance of a consistent water pressure as the water passes from the water pipes 12 into the system 10 and subsequently returns into the water pipes 12. Additionally, it is contemplated that the impeller blades 26 are constructed with materials promoting stability while the blades 26 are operable in the system 10.

In this regard, in the present embodiment the impeller blades 26 are constructed of materials that require minimal maintenance and optimal longevity. Such materials include stainless steel, ceramic, composite, or the like. Generally, materials such as wood have a tendency to rot or erode and require replacement and routine maintenance. Additionally, in the present embodiment the housing 14 is fitted with an outer housing cover 28. The outer housing cover 28 substantially covers an upper portion of the impeller 24. Additionally, the outer housing cover 28 may be removed to provide access to the open space 16. Thus, the outer housing cover 28 may be removed to maintain or replace an impeller 24 or impeller blade 26.

The impeller blades 26 are sized relative to the existing water pipes 12. In this regard, the size of the water pipe 12 is generally indicative of the amount of water capable of flowing through the pipe 12. In order to maintain the one blade under water design, it is critical to precisely determine the amount of water flowing through the pipes 12 so the impeller blades 26 are configured accordingly. The inline hydro electric system 10 is capable of accommodating a variety of water pipes 12 including conventional existing water pipes. Generally, standard water pipes 12 around the world have a diameter between 18 to 54 inches. In the present embodiment, the impeller blades are sized so that they have a length ⅓ of the size of the diameter of a water pipe 12. This sizing formula has been found to give the impeller blade 26 sufficient space to operate effectively. Additionally, the impeller blades 26 are designed to withstand the forces of continuous water pressure. In this regard, the varying pressure of the water current may result in the in the impeller blades 26 to bend. As a result, the impeller 24 includes support structures 30 positioned in between each impeller blade 26 to provide support to the impeller blades 26 as they rotate through the water. In addition, the impeller 24 should be rigidly affixed within the open space 16 so that the pressure of the water current does not cause the impeller 24 to be dismounted and swept away. It is advantageous to provide a degree of rigidity to the construction of the system, as any maintenance needed by the system may affect electrical power generated.

An electrical generator 32 is mounted on the housing 14 and is axially coupled to the impeller 24. The electrical generator 32 is designed to work in tandem with the impeller 24 to generate electrical power upon the rotation of the impeller 24. It is contemplated that the electrical generator 32 may be attached outside or inside of the housing 14. The positioning of the electrical generator 32 depends, in part, on the nature of the existing water pipe 12. In this regard, certain water pipes 12 run under bodies of water or under certain terrain unsupportive of exposing an electrical generator 32 to the surrounding environment. As such, in these environments it is contemplated that the electrical generator 32 be mounted within the open space 16 inside of the housing 14.

In the present embodiment, the electrical generator 32 is mounted on the outside of the housing 14 as illustrated in FIGS. 1 and 2. This configuration allows for easy access to the electrical generator 32 for maintenance without disrupting the remaining system 10. In addition, certain electrical generators 32 are large in size and would require a substantially large housing 14. Additionally, an electrical generator 32 mounted inside of the housing must be adapted with safeguards to ensure the components of the generator 32 are water proofed.

A standard electrical generator may effectively be employed within the system. In the present embodiment, the electrical generator 32 is a synchronous or induction brushless revolving field generator with a directed connected rotated brushless exciter. A synchronous or induction brushless revolving field generator 32 is configured for continuous hydro service and has a temperature rise of 80 degrees Celsius by resistance over 40 degrees Celsius ambient. Additionally, the generator has a runaway speed of 1620 RPM. Additionally, the generator has a weight of 33,000 pounds and includes a Basler DECS 200 digital voltage regulator. In the present embodiment, the synchronous or induction revolving field generator 32 is of a two bearing design with a shaft extension suitable for direct drive. In this regard, the impeller 24 has an opening 34 positioned at the core of the impeller. The electric generator 32 is axially coupled to the opening 34 via a rotatable drive shaft 36. As a result of the impeller 24 rotating, the drive shaft 36 consequently rotates thereby stimulating the generation of electrical power within the generator 32.

A bearing 38 is used to secure the drive shaft 34 to the housing 14. In the present embodiment, there are two bearings 38 used to secure the drive shaft 34. In addition, the bearings 38 promote the rotation of the drive shaft 34. It is contemplated that the use of a synchronous or induction brushless revolving field generator 32 axially coupled to the impeller 14 will yield a minimum of 250 kilowatts to a maximum of 10 megawatts of electrical power. However, a person having ordinary skill in the art will understand that the electrical generator 32 and the impeller 14 may be configured to conform to a consuming communities requisite need. In addition, it is estimated that the present embodiment of the inline hydro electrical generation system 10 is capable of delivering the equivalent energy of electrical generation plants or alternative energy systems at 25% of the associated costs.

The inline hydro electric generation system 10 is adaptable for multi-unit deployment in an existing or future water pipe system. The adaptability of the system 10 advantageously allows for the system 10 to accommodate the needs of growing communities. It has been found that the system 10 is most resourcefully deployed when units are installed in half mile increments along a water pipe 12. Such a deployment promotes maximum energy output while maintaining sufficient water pressure. In this regard, the system 10 is environmentally friendly when viewed in light of its alternatives. Additionally, the installation of the system 10 does not require the extensive approval process from municipalities that power plants or construction of dams would require. Therefore, the rapid deployment of the system can provide immediate cost effective, energy efficient, and clean energy. In addition, it is well known that nearly every community in the industrialized world has a water pipeline delivery system in place, including communities in remote and isolated locales. Therefore, the current system may be deployed to effectively and efficiently provide energy to all locales without the need for implementing large-scale energy projects.

Further in accordance with the present invention, there is also provided a method for generating electrical power from an inline hydro electric generation system that is employed to a water pipe 12. The method initiates by providing a housing 14 defining an internal open space 16 and at least one inlet 18 and outlet openings 20, the inlet opening 18 is attached to a water pipe 12 so that water flows into the housing 14, and the outlet opening 20 is attached to the water pipe 12 so that water flows from the housing 14 back into the water pipe 12. The method continues by providing a rotatable impeller 24 mounted in the open space 14 between the inlet 18 and outlet 20 openings and having a plurality of radially extending impeller blades 26, wherein the impeller blades are configured so that only one blade 26 is submerged under water during the rotation of the impeller 24. An electrical generator 32 is axially coupled to the impeller 24 so that when the impeller 24 rotates the electrical generator 32 produces electrical power. The method continues by passing a flow of water from a water pipe 12 through the inlet opening so that the impeller 24 rotates which subsequently generates electrical power from the electrical generator 32. The method concludes by passing the flow of water from the housing 14 through the outlet opening 20 back into the water pipe 12.

The particulars shown herein are by way of example and for the purpose of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. An inline hydro electric generation system, comprising:
a housing defining an internal open space and at least one opposed inlet and outlet openings for receiving a flow of water therethrough;
a rotatable impeller mounted in the open space in between the inlet and outlet openings and having a plurality of radially extending impeller blades about its periphery, each impeller blade positioned at angular intervals relative to a plane including the axis of the impeller; and
an electric generator mounted on the housing and configured to be axially coupled to the impeller for generating energy upon the rotation of the impeller;
wherein the housing is affixed to a water pipe so that water from the water pipe flows in through the inlet opening and out though the outlet opening and the impeller is axially rotated by the current of the water; and wherein the impeller blades are configured so that only one impeller blade is submerged under water during a rotation.

2. The inline hydro electric generation system of claim 1, wherein the impeller blades have a leading and a trailing end.

3. The inline hydro electric generation system of claim 2, wherein the leading end is rounded.

4. The inline hydro electric generation system of claim 1, wherein the impeller blades have grooves embedded upon the body of the blade.

5. The inline hydro electric generation system of claim 1, wherein the impeller blades are configured to be positioned at 72 degree angles in relation to the axis of the impeller.

6. The inline hydro electric generation system of claim 1, wherein the impeller blades are made of ceramic.

7. The inline hydro electric generation system of claim 1, wherein the impeller blades are made of stainless steel.

8. The inline hydro electric generation system of claim 1, wherein the impeller blades are made of composite.

9. The inline hydro electric generation system of claim 1, wherein the impeller blades have a length ⅓ the size of the diameter of the water pipe.

10. The inline hydro electric generation system of claim 1, wherein the impeller further comprises a plurality of support structures positioned in between each impeller blade so that the impeller blades are supported when rotated through the water.

11. The inline hydro electric generation system of claim 1, wherein the water pipes are conventional in ground water pipes.

12. The inline hydro electric generation system of claim 1, wherein the housing further comprises:
an inlet attachment point;
an outlet attachment point; and
a removable outer housing cover that substantially covers an upper portion of the impeller;
wherein the inlet and outlet attachment points are retrofitted to the water pipe and secured with unions so that water flows through the housing and the water pressure remains constant.

13. The inline hydro electric generation system of claim 10, wherein the outer housing cover is removed to provide access to the open space.

14. The inline hydro electric generation system of claim 1, wherein the electric generator is mounted in the open space of the housing.

15. The inline hydro electric generation system of claim 1, wherein the electric generator is a synchronous brushless revolving field generator.

16. The inline hydro electric generation system of claim 1, wherein the electric generator is an induction brushless revolving field generator.

17. The inline hydro electric generation system of claim 1, wherein the impeller further comprises a core opening positioned at the center of the impeller;
wherein a rotatable drive shaft axially couples the electric generator to the core opening so that when the impeller rotates the rotatable drive shaft rotates and the electrical generator generates electrical power.

18. The inline hydro electric generation system of claim 11, wherein the inline hydro electric generation system is adapted for multi-unit deployment in a water pipe system.

19. An inline hydro electric generation system for generating electrical power from water passing through a water pipe, comprising the steps of:
a) providing a housing defining an internal open space and at least one inlet and outlet openings, the inlet opening is attached to a water pipe so that water flows into the housing, and the outlet opening is attached to the water pipe so that water flows from the housing back into the water pipe;
b) providing a rotatable impeller mounted in the open space between the inlet and outlet openings and having a plurality of radially extending impeller blades, wherein the impeller blades are configured so that one blade is submerged under water during the rotation of the impeller;
c) providing an electrical generator axially coupled to the impeller so that when the impeller rotates the electrical generator produces electrical power;
d) passing a flow of water from a water pipe through the inlet opening so that the impeller rotates;
e) generating electrical power from the electrical generator; and
f) passing the flow of water from the housing through the outlet opening into the water pipe.
